(19) United States
(12) Patent Application Publication
(10) Pub. No.: US 2023/0312051 A1
(43) Pub. Date: Oct. 5, 2023

(54) ANGLE VARIATION SYSTEM FOR ELLIPTICAL BIKES

(71) Applicant: ARUANÃ ENERGIA S/A, Goiânia (BR)

(72) Inventors: Brian Ray Brewer, São Paulo (BR); Robert James McKinnon, São Paulo (BR)

(21) Appl. No.: 18/192,189

(22) Filed: Mar. 29, 2023

(30) Foreign Application Priority Data
Mar. 30, 2022 (BR) 102022006059-2

(51) Int. Cl. B62M 1/26; B62K 15/00; B62K 3/00; B62K 19/30

(52) U.S. Cl. CPC B62M 1/26; B62K 3/002; B62K 15/006; B62K 19/30

(57) ABSTRACT

An elliptical bike is described having a function that elliptical bikes of the related art do not have, since their rear pulleys, which support the platforms, are screwed into protrusions welded to the frame, which have holes. The bicycle also comprises a folding embodiment, and holes that are suitable for raising and lowering the angle of attack of the platforms and the positioning of the rear pulleys, which are fixed (e.g., screwed) into protrusions welded to the frame, thereby providing four positions of angle of attack, giving the option to work different muscles in the user’s legs.

### CROSS-REFERENCE TO RELATED APPLICATION

This application claims the benefit of and priority to Brazil Patent Application No. 102022006059-2 filed Mar. 30, 2022, the contents of which being incorporated by reference in their entirety herein.

### TECHNICAL FIELD

The present disclosure belongs to the field of elliptical bicycles, whereby a function that the elliptical bicycles of the related art fail to provide is described. According to the present disclosure, elliptical bicycles are described having rear pulleys, which support platforms, are screwed or otherwise fixed into protrusions welded to the frame, which have holes. These holes are suitable for raising and lowering the angle of the platforms, giving the option of working different muscles in the user’s legs.

### BACKGROUND

The use of bicycles, as is widely known, brings many benefits to the user, such as a fitness activity, the reduction of a sedentary lifestyle and diseases, the fight against obesity, among other pathologies, in addition to being an alternative and environmentally friendly means of transportation, reducing the levels of polluting gases of conventional vehicles.

Several types of bicycle models are known, such as mountain bikes, hybrid bicycles, touring and leisure bicycles, bicycles with front suspension, among others, which, in general, are composed of monobloc frames where the front and rear forks are installed, as well as wheels and tires, ratchet, movement transmission mechanism, saddle, handlebars, brake mechanism, in addition to other equipment such as basket, car seat, etc.

Likewise, “elliptical” bicycles are also known. They promote all the benefits already mentioned of the common bicycle in a different way: emulating the human step, through its elliptical movement, being a natural way of ambulating the human body, without the impact associated with running that can cause damage to the muscles and tissues of connection between muscles and bones.

Elliptical bicycles, unlike normal bicycles, help in the development of different parts of the musculature, since the way the user uses the bicycle is “standing” and not “sitting” as in the common bicycle, that is, the user supports the feet on platforms, remaining upright while driving the bike, completely dispensing with the use of saddles.

More specifically, an elliptical bike consists of a structural frame with at least two wheels, one front and one rear, and includes a mechanism for activating a crankset associated with the ratchet by means of the belt and where a pedal crank is driven by a pair of platforms, each of which has one end mounted on a crank arm and the other end articulated to the respective support arranged at the rear of the frame, close to the rear wheel. Thus, the alternating movement of the platforms between raising and lowering each support platform promotes forward movement of the bicycle.

The applicant, acting in the area as a developer of mechanisms for elliptical bicycles and the like, is the applicant for document BR102012028693, which refers to a bicycle whose drive assembly allows it to be driven by the cyclist in the upright position and, therefore, provides that each of the pedals is articulated by its front end, at the ends of the respective cranks ; each of the pedals is continued on a guide rod; the guide rods are, in turn, supported on the rear set of the sliding supports, whose set is formed by a transverse tube incorporated horizontally to the structure and receiving, at each of its ends, a roller whose channel is sized to accommodate the crossbeam section of the guide rod.

Document BR10201302584, in turn, refers to an elliptical velocipede such as bicycles, tricycles and scooters with a tubular spar where the basic parts are mounted, namely: fork, handlebar support, front wheel, rear wheel, central crown, cranks, as well as the elliptical drive mechanism and steering mechanism.

Document BR102017003989 also teaches an elliptical bicycle model, where a structural frame composed of two spars in opposite arcs, one upper and one lower, a front wheel and a rear wheel driven by a crank of their support platforms, as well as a box consisting of a fork, steerer tube and handlebar. The elliptical trainer according to this document has several hinges. The structural frame is supplied with a set of main hinges, each applied to a split spar pivoting at an approximate angle of up to 170°. A secondary hinge is applied to a split handlebar head tube with a hinge at an approximate angle of up to 180°. A set of tertiary hinges are fitted between a crankset and the user’s footrest platforms, each of which pivots at an approximate angle of up to 90° upwards.

Other models of elliptical bikes are known on the market, as this type of bike has become an increasingly common vehicle, but although these models of “elliptical” bikes bring countless benefits to users, it is worth noting that none of them teaches the possibility to raise and lower the angle of attack of the platforms, giving the option of working different muscles in the legs.

### BRIEF SUMMARY

The set according to the present disclosure applies to an elliptical bike which has a function that others do not: the rear pulleys that support the platforms are screwed into welded protrusions on the frame, which have holes. Such holes can be used to raise and lower the angle of attack of the platforms, giving the option to work different muscles in the legs. In a second embodiment, the elliptical bike is foldable.

### BRIEF DESCRIPTION OF THE DRAWINGS

Complementing the present description, in order to obtain a better understanding of the characteristics of the present disclosure and in accordance with a preferred practical embodiment of the same, the present application presents a set of attached drawings, where, by way of example, although not limiting, its operation was represented:

FIG. 1A illustrates the elliptical bike exerciser assembly according to the present disclosure, FIG. 1B illustrates the assembly in folding elliptical bike exerciser mode, and FIG. 1C emphasizes the four anticipated angle positions;

FIG. 2A illustrates the elliptical bike exerciser assembly according to the present disclosure, FIG. 2B illustrates the assembly in folding elliptical bike exerciser mode, and FIG. 2C emphasizes the first predicted angle position (FIG. 2A);

FIG. 3A illustrates the elliptical bike exerciser assembly according to the present disclosure, FIG. 3B illustrates the assembly in folding elliptical bike exerciser mode, and FIG. 3C emphasizes the second predicted angle position;

FIG. 4A illustrates the elliptical bike exerciser assembly according to the present disclosure, FIG. 4B illustrates the assembly in folding elliptical bike exerciser mode, and FIG. 4C emphasizes the third predicted angle position; and

FIG. 5A illustrates the elliptical bike exerciser assembly according to the present disclosure, FIG. 5B illustrates the assembly in folding elliptical bike exerciser mode, and FIG. 5C emphasizes the predicted fourth angle position.

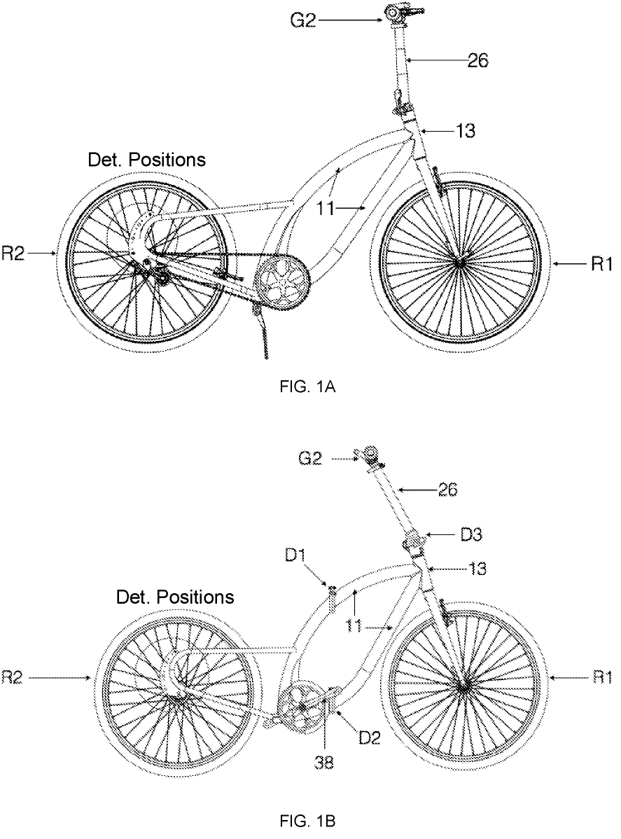

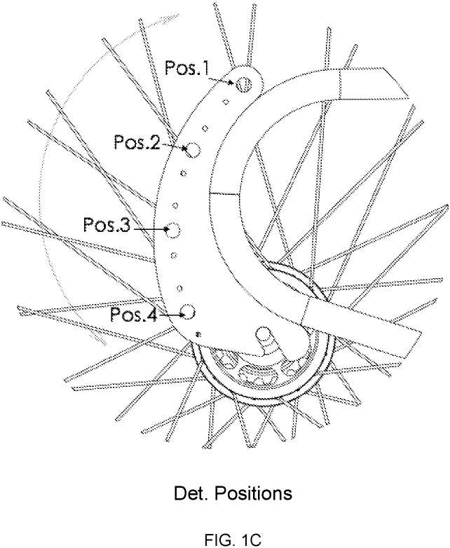

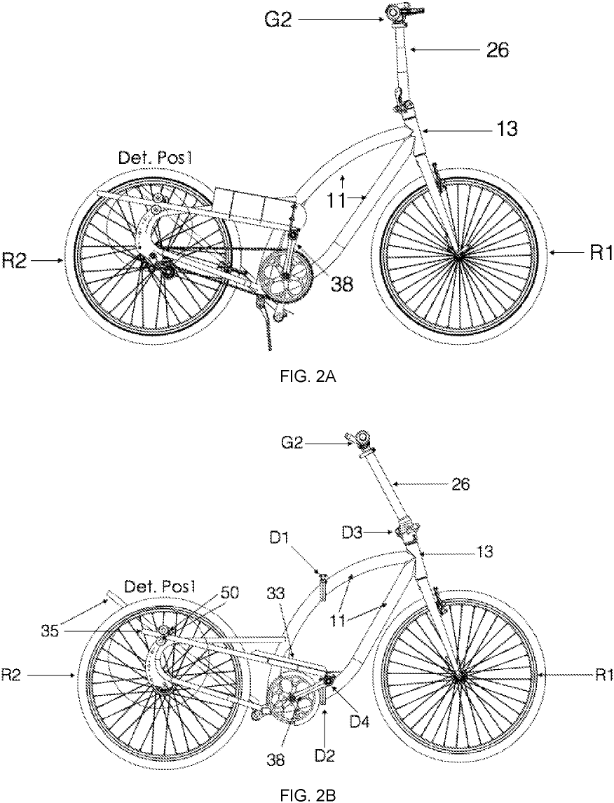

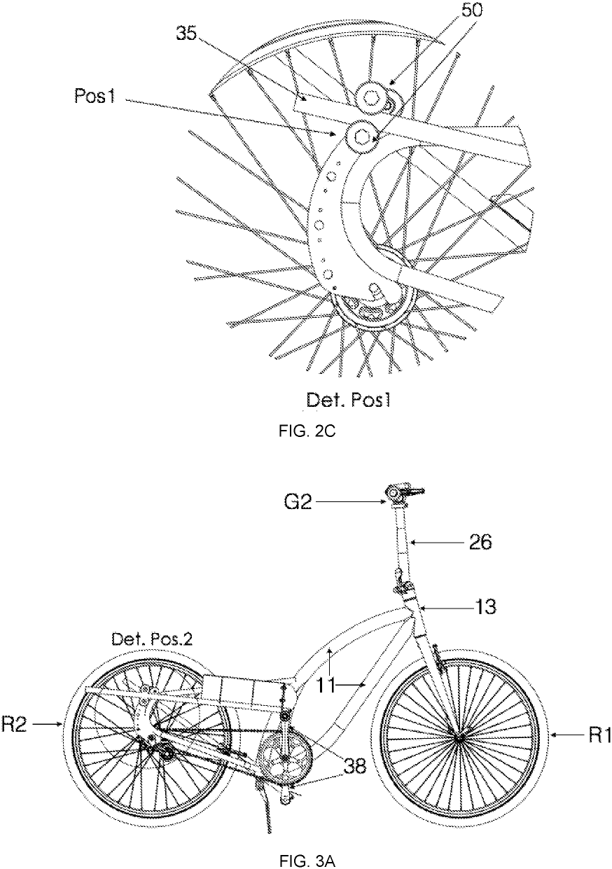

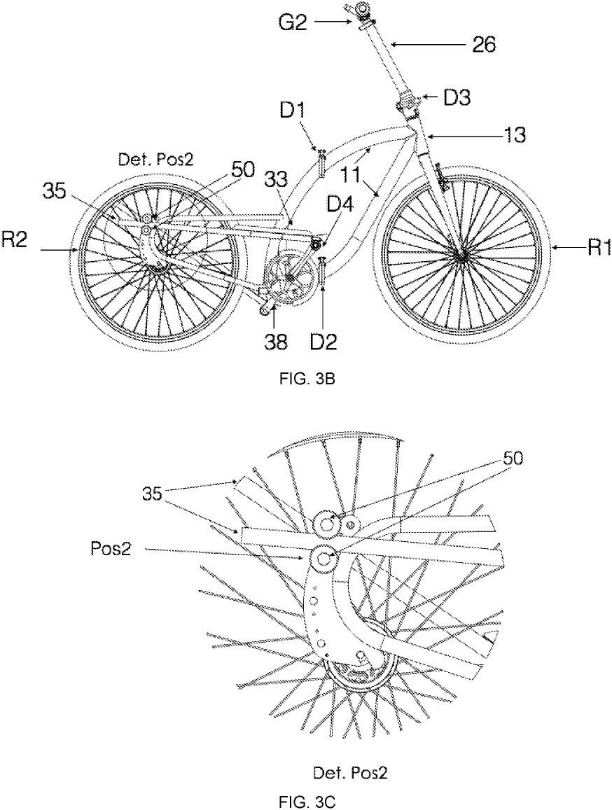

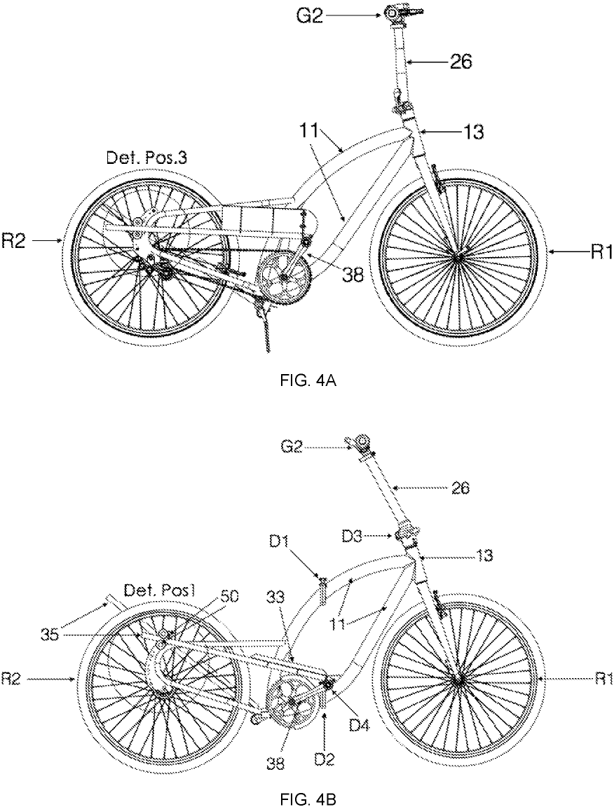

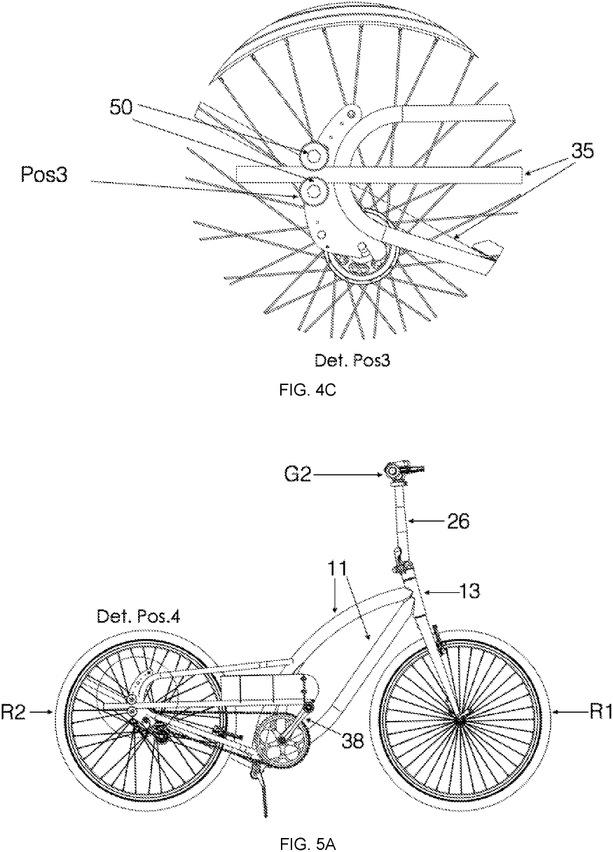

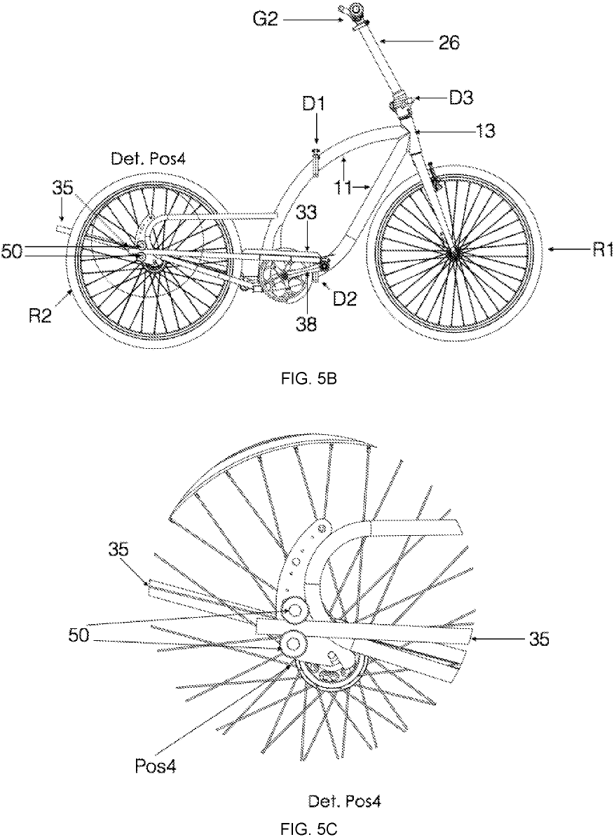

### DETAILED DESCRIPTION

With reference to the illustrated drawings, the present disclosure relates to an elliptical bike comprising a function that the elliptical bikes of the related art do not have, since their rear pulleys, which support the platforms, are screwed in protrusions welded in the frame, which have holes or detents. These holes or detents are suitable for raising and lowering the angle of attack of the platforms, giving the option of working different muscles in the user’s legs.

It is also worth mentioning that the elliptical bike according to the present disclosure can be presented in a folding mode and, with that, still brings a great advantage in terms of transportability.

In the folding mode, the frame (11) of the bicycle according to the present disclosure has its front part coupled to a tubular segment (13) responsible for supporting the fork (G1) of the front wheel (R1) and the steering tube (26) of the handlebar (G2), this steering tube (26) being bipartite and joined by the secondary hinge (D3) with 180° articulation.

The other end of the frame (11) is joined to the bearing of the tubular segment (35) of a crank which, in turn, through each rod (38), has a respective tertiary hinge (D4), responsible for articulating a bar (35) of the support platform (33) at a predetermined angle (e.g., 90°), the support bar (35) having its other end installed in a pair of double pulleys (50) arranged in the region of the rear wheel (R2). More specifically the rear pulleys (50) are screwed or otherwise fixed into welded protrusions on the frame, which have appropriate holes for four angle of attack positions (P1, P2, P3, P4).

The hinges (D1), (D2), (D3), and (D4), when disassembled, allow the elliptical bike to be reduced by up to ⅓ of its volume. The association of all joints resulting from hinges (D1), (D2), (D3), and (D4) comprises the dimensional compaction of the elliptical bicycle (10).

In the conventional elliptical mode, the frame (11) of the bicycle according to the present disclosure has its front part coupled to a tubular segment (13) responsible for supporting the fork (G1) of the front wheel (R1) and the steering tube (26) of the handlebar (G2).

The other end of the frame (11) joins the bearing of the tubular segment (35) of a crank in which, in turn, the support bar (35) has one end installed on a pair of double pulleys (50) arranged in the region of the rear wheel (R2). More specifically, the rear pulleys (50) are screwed into welded protrusions on the frame, which have appropriate holes for four angle of attack positions (P1, P2, P3, P4).

In both embodiments, the positioning of the rear pulleys (50), which are screwed into welded protuberances on the frame, provides four angle of attack positions (P1, P2, P3, P4).

In the first position, the rear pulleys (50) are screwed in position P1 of the welded protuberances on the frame, having the most acute angle of inclination. In the second position, the rear pulleys (50) are screwed in position P2 of the protrusions welded to the frame, with an intermediate angle of inclination, just as when the rear pulleys (50) are screwed in position P3 of the protrusions welded to the frame, which lead to a second intermediate angle of inclination. However, when the rear pulleys (50) are screwed in position P4 of the protrusions welded to the frame, the smoothest possible angle of inclination is obtained. The different angle allows the option to work different muscles in the user’s legs.

It is important to point out that, when the present disclosure is put into practice, modifications can be made in relation to certain construction and form details, without evasion from the fundamental principles that are clearly founded in the context of the claims, it being understood that the terminology employed is not intended to limit the disclosure.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A folding elliptical bike, comprising:
a front wheel and a rear wheel; and
a frame having a front end coupled to a tubular segment for supporting a fork of the front wheel and a steering tube of handlebars,
wherein the steering tube is bipartite and joined by a secondary hinge with 180° articulation,
wherein a second end of the frame joins a bearing of a tubular segment of a crank that, in turn, through each rod, has a respective tertiary hinge for articulating a bar of a support platform at an angle of 90°,
wherein the support bar has its other end installed in a pair of double pulleys arranged in a region of the rear wheel, and
wherein the rear pulleys are fixed into welded protuberances on the frame, with four possible angle of attack positions.

2. The folding elliptical bike according to claim 1, wherein the rear pulleys are screwed in position P1 of the protrusions welded to the frame, with the most acute angle of inclination possible.

3. The folding elliptical bike according to claim 1, wherein the rear pulleys are screwed in position P2 of the protrusions welded to the frame.

4. The folding elliptical bike according to claim 1, wherein the rear pulleys are screwed in position P3 of the protrusions welded to the frame.

5. The folding elliptical bike according to claim 1, wherein the rear pulleys are screwed in position P4 of the protrusions welded to the frame, with the smoothest angle of inclination possible.

6. An elliptical bike, comprising:
a front wheel and a rear wheel;
a frame having a front end coupled to a tubular segment for supporting a fork of the front wheel and a steering tube of handlebars,
wherein the steering tube is bipartite and another end of the frame joins a bearing of a tubular segment of a crank in which, in turn, a support bar has one end installed on a pair of double pulleys arranged in the region of the rear wheel,
wherein the rear pulleys are fixed into welded protrusions on the frame, with four possible angle of attack positions.

7. The elliptical bike according to claim 6, wherein the rear pulleys are screwed in position P1 of the protrusions welded to the frame, with the most acute angle of inclination possible.

8. The elliptical bike according to claim 6, wherein the rear pulleys are screwed in position P2 of the protrusions welded to the frame.

9. The elliptical bike according to claim 6, wherein the rear pulleys are screwed in position P3 of the protrusions welded to the frame.

10. The elliptical bike according to claim 1, wherein the rear pulleys are screwed in position P4 of the protrusions welded to the frame, with the smoothest angle of inclination possible.

11. An elliptical bike, comprising:
a front wheel and a rear wheel;
a frame having a front end coupled to a tubular segment for supporting a fork of the front wheel and a steering tube of handlebars,
wherein the steering tube is not bipartite and another end of the frame joins a bearing of a tubular segment of a crank in which, in turn, a support bar has one end installed on a pair of double pulleys arranged in the region of the rear wheel,
wherein the rear pulleys are fixed into welded protrusions on the frame, with four possible angle of attack positions.

12. The elliptical bike according to claim 11, wherein the rear pulleys are screwed in position P1 of the protrusions welded to the frame, with the most acute angle of inclination possible.

13. The elliptical bike according to claim 11, wherein the rear pulleys are screwed in position P2 of the protrusions welded to the frame.

14. The elliptical bike according to claim 11, wherein the rear pulleys are screwed in position P3 of the protrusions welded to the frame.

15. The elliptical bike according to claim 11, wherein the rear pulleys are screwed in position P4 of the protrusions welded to the frame, with the smoothest angle of inclination possible.

16. A method comprising providing the folding elliptical bike according to claim 1.

17. A method comprising providing the elliptical bike according to claim 6.

18. A method comprising providing the elliptical bike according to claim 11.
